(19) United States
(12) Patent Application Publication
(10) Pub. No.: US 2020/0238557 A1
(43) Pub. Date: Jul. 30, 2020

(54) THERMALLY ACTUATED FIBRE OPTIC CUTTING DEVICE

(71) Applicant: PYROPTIC PTY LTD, Talbingo, New South Wales (AU)

(72) Inventor: Richard Stuart, Talbingo, New South Wales (AU)

(21) Appl. No.: 16/650,276

(22) PCT Filed: Sep. 28, 2018
(86) PCT No.: PCT/AU2018/051064

§ 371 Date: Mar. 24, 2020

(30) Foreign Application Priority Data
Sep. 28, 2017 (AU) 2017903929

(51) Int. Cl. B26D 5/08; G01K 11/06

(52) U.S. Cl. CPC B26D 5/08; G01K 11/06

(57) ABSTRACT

A thermally actuated fibre optic cutting device including: a housing configured to receive an optical fibre element which passes through the housing from one side of the housing to another side of the housing in one continuous portion, wherein the optical fibre element is capable of transmitting a source of light along its length; one or more retaining portions for retaining the optical fibre element; and, a cutting element disposed within the housing for cutting the continuous portion of the optical fibre element in response to a change in temperature, the cutting element being moveable in a direction towards the continuous portion of the optical fibre element.

### BACKGROUND

The present invention seeks to provide a thermally actuated fibre optic cutting device which may be used to provide a relatively inexpensive temperature sensor that provides a mechanism for determining whether a predetermined temperature has been reached in the location of the sensor. The present invention also seeks to provide a temperature sensor that is able to signal that a predetermined temperature has been reached in a location that may be difficult to access.

### SUMMARY

According to one aspect there is provided a thermally actuated fibre optic cutting device including:
a housing configured to receive an optical fibre element which passes through the housing from one side of the housing to another side of the housing in one continuous portion, wherein the optical fibre element is capable of transmitting a source of light along its length;
one or more retaining portions for retaining the optical fibre element; and,
a cutting element disposed within the housing for cutting the continuous portion of the optical fibre element in response to a change in temperature, the cutting element being moveable in a direction towards the continuous portion of the optical fibre element.

In one form the continuous portion of the optical fibre element is cut by the cutting element at a location adjacent the retaining portion when the cutting element is moved towards the optical fibre element. In one form the cutting element cuts the continuous portion of the optical fibre element by shearing through the optical fibre.

In one form the optical fibre element is in the form of one continuous length which begins at one end outside of the housing and ends at another end outside of the housing.

In one form the cutting element is moved towards the continuous portion of the optical fibre element by a material that physically transforms due to the change in temperature wherein the material that physically transforms is contained within the housing. In one form the material that physically transforms is located towards and contained within one end of the housing, the cutting element is positioned adjacent the material that physically transforms, and the continuous portion of the optical fibre element is located on the other side of the cutting element from the material that physically transforms.

In one form the cutting element includes a cutting surface located on the other side of the cutting element from the material that physically transforms and facing the continuous portion of the optical fibre element wherein the cutting surface is capable of severing the continuous portion of the fibre optic element adjacent the retaining portion when moved towards the continuous portion of the optical fibre element.

In one form a seal member is located between the material that physically transforms and the cutting element. In one form the seal member is in the form of a hydraulic seal.

In one form, upon the change in temperature, the material that physically transforms urges the seal member and the cutting element together towards the continuous portion of the optical fibre element.

In one form the optical fibre element passes through the housing from one side of the housing to another side of the housing in one continuous portion via two openings located in the housing, wherein the one or more retaining portions is provided by at least one or both of the perimeter surfaces of the two openings whereby the continuous portion of the fibre optic element is retained by the perimeter surface of the or both openings from moving in a direction away from the cutting element. In one form the perimeter surfaces of the two openings are circular in form and have a clearance fit around the optical fibre element to allow it to easily slide through.

In one form the cutting surface of the cutting element moves along an inside surface of the housing when moved towards the continuous portion of the optical fibre element. In one form the housing includes a cylindrical form at the location of the one or more retaining portions and the cutting surface includes a complementary shape which moves along an inside surface of the housing.

In one form the cutting element includes a cylindrical portion including a cutting surface provided by a perimeter region located on the cylindrical portion, the cutting surface surrounding a concave central region, wherein the perimeter region of the cutting element provides a complementary shape to the inside surface of the housing.

### BRIEF DESCRIPTION OF THE ACCOMPANYING FIGURES

The present invention will become better understood from the following detailed description of various non-limiting embodiments thereof, described in connection with the accompanying figures, wherein:

FIG. 1 is a schematic cross-sectional view of an embodiment of a thermally actuated fibre optic cutting device

FIG. 2 is a schematic cross-sectional view of the embodiment of the thermally actuated fibre optic cutting device of FIG. 1 showing the cutting element cutting the continuous length of optical fibre in response to a change in temperature;

FIG. 3 is a perspective view of a housing in accordance with an embodiment of a thermally actuated fibre optic cutting device;

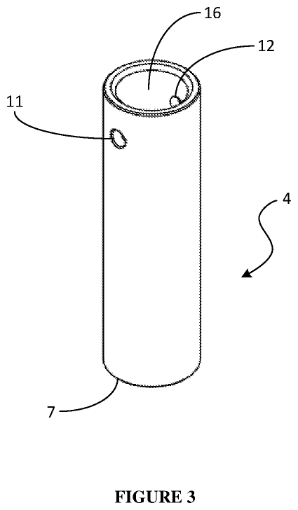

FIG. 4 is a sectional side elevation and a sectional front elevation of the housing of FIG. 1;

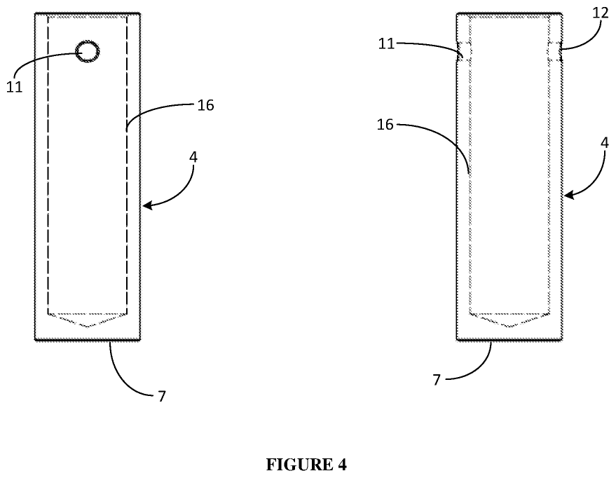

FIG. 5 is a side elevation of an another embodiment of a housing;

FIG. 6 is a perspective view of a seal member in accordance with an embodiment of a thermally actuated fibre optic cutting device; and,

FIG. 7 is a front elevation of a cutting element in accordance with an embodiment of a thermally actuated fibre optic cutting device.

### DETAILED DESCRIPTION OF EMBODIMENTS AND THE ACCOMPANYING FIGURES

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

As used herein the term “optical fibre” or “optical fibre element” refers to a flexible, transparent fibre made by drawing glass (silica) or plastic. The optical fibre elements that may be used in accordance with embodiments described herein may be of any suitable diameter and may include diameters of between about 50 and 1000 microns. In one embodiment the diameter of the optical fibre elements includes a jacket outer diameter of 1000 microns and core diameter of 500 microns. In one embodiment the optical fibre element has a core constructed of PMMA. An optical fibre is able to transmit a source of light along its length between the two ends of the fibre. The optical fibre elements in accordance with various embodiments are described as including a “lead end” and a “trailing end” for simplicity. However it is important to appreciate that the “lead end” and the “trailing end” are interchangeable and that optical fibre elements are not polarity sensitive as light may be communicated in either direction along the length of the optical fibre.

Optical fibres are typically composed of a transparent core surrounded by a transparent cladding material with a lower index of refraction. Light is kept in the core by the phenomenon of total internal reflection. The use of optical fibres for signalling a temperature reading from a temperature sensor provides significant advantages over the alternative of using metal wires, particularly because optical fibres are very good insulators and immune to electromagnetic interference. This provides that the use of optical fibres enables a fibre optic temperature sensor to be used in locations that include high voltages and/or significant electromagnetic interference.

As used herein the term “a material that physically transforms” refers to a material that is able to undergo a physical change in its state such as its shape, volume or form. Examples of a material that physically transforms include bimetallic materials, shape memory materials such as Nitinol and thermally expanding material.

In accordance with one embodiment there is provided a thermally actuated fibre optic cutting device which will activate over a predetermined temperature range. The temperature of the thermally actuated fibre optic cutting device is affected by the environment it is exposed too. A continuous optical fibre element including a lead end and a trailing end is incorporated into the assembly of the thermally actuated fibre optic cutting device with the optical fibre element capable of communicating a source of light through the assembly of the thermally actuated fibre optic cutting device and along the length of the continuous optical fibre element from one to the other end. Upon the temperature of the thermally actuated fibre optic cutting device reaching the predetermined value, the cutting element is configured to cut the continuous optical fibre element at the location of the thermally actuated fibre optic cutting device which thereby disrupts the ability of the continuous optical fibre element to communicate the source of light from the lead end to the trailing end.

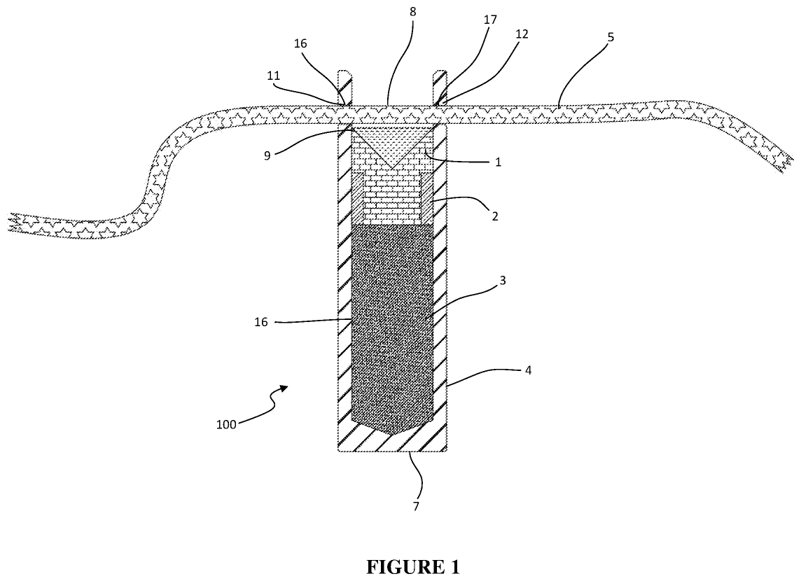

Referring to FIG. 1 there is shown an embodiment of a thermally actuated fibre optic cutting device 100 in accordance with the present invention which includes the following components: a cutting element 1, a seal member 2, a material that physically transforms 3, which in this embodiment is chosen from a thermally expanding material such as a wax composition, and a housing 4. In this embodiment, the housing is in the form of a hollow cylinder with a closed end 7. In the assembled state of the thermally actuated fibre optic cutting device 100, the housing 4 contains the cutting element 1, the seal member 2 and the material that physically transforms 3. The cutting element 1 has a cylindrical main body portion 15 which is slightly smaller in diameter than the inside surface 16 of the cylindrical housing 4. This assembly provides that the cutting element 4 may move along the inside surface 16 of the cylindrical housing 4 with the cylindrical body portion 15 forming a complementary surface along the inside surface 16 of the housing 4.

The housing 4 further includes openings 11 and 12 which may be positioned on substantially opposite sides of the housing 4. The openings 11 and 12 allow a portion of a continuous optical fibre element 5 to pass through the housing 4 from one side of the housing 4 to the other side of the housing leaving a continuous portion 8 of the optical fibre element 5 passing though the hollow interior of the housing 4. The openings 11 and 12 include retaining portions 16, 17 which are in the form of the peripheral surfaces of the openings 11, 12 positioned in the direction moving away from the bottom end 7 of the housing. The openings 11 and 12 and the retaining portions 16, 17 form a clearance fit around the exterior surface of the optical fibre element 5 to allow it to freely pass through. The retaining portions 16, 17 function to hold the optical fibre element 5 at a location next to, or adjacent to where the cutting element 1 moves into contact with the optical fibre element 5 during actuation of the fibre optic cutting device, and in doing so provide the necessary retaining portions for the cutting element to act against. The optical fibre element 5 is both flexible and very tough and as such it is preferable that the retaining portions 16, 17 support the optical fibre element 5 and prevent the optical fibre element from moving in a direction away from the bottom end 7 of the housing 4 when the cutting element 1 comes into contact with the optical fibre element to enable a successful cut. If the optical fibre element 5 is not held close to where the point of contact with the cutting element 1, the optical fibre element 5 will flex and remain intact, rather than severing.

The material that physically transforms 3 is selected to physically transform once the temperature of the thermally actuated fibre optic cutting device reaches a predetermined temperature threshold caused by heat transferred from the environment it is exposed to. In one example embodiment, the material that physically transforms 3 is chosen from a material that thermally expands such as a wax composition which undergoes significant thermal expansion during its phase change from solid to liquid. The temperature at which a wax composition changes from solid to liquid may be altered by the specific composition of the wax. As a result, a wax may be chosen to be suitable in accordance with certain embodiments where the wax changes from a solid to a liquid at or near the predetermined temperature threshold or value. The composition of the wax may be chosen such that it undergoes a phase change at a variety of temperatures such as for example from temperatures ranging from 20° C. to about 125° C. In one embodiment, the thermally expanding wax may be chosen from a thermostat wax such as for example an Astorstat® wax. Advantageously, the use of a solid thermostat wax as the selection for the material that physically transforms 3 ensures there is little to no chemical degradation of internal components of the thermally actuated fibre optic cutting device 100 such as the seal member 2, or the housing 4 over time.

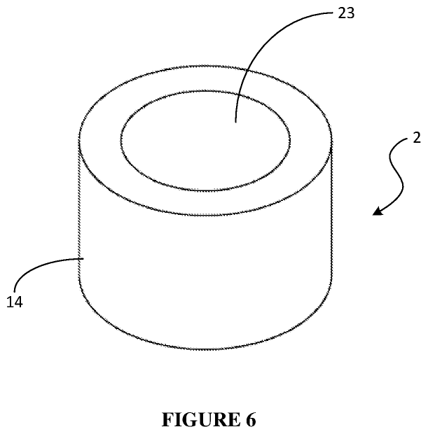

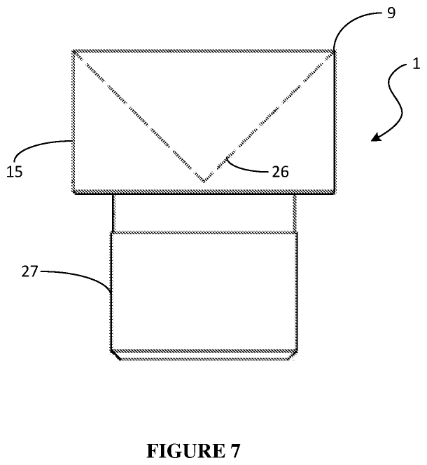

The seal member 2 is situated between the material that physically transforms 3 and the cutting element 1 whereby the seal member 2 is moved in the direction towards the optical fibre 4 as a result of the material that physically transforms 5 changing its physical form upon the temperature reaching the predetermined threshold. In an example embodiment, the seal member 2 may be composed of Teflon or other suitable material that is able to create a hydraulic seal against the internal surface of the housing 4. FIG. 6 depicts a seal member 2 in accordance with one embodiment which is in the form of a cup shape including a cylindrical outer surface 14 which is slightly lesser in diameter than the interior of the housing 4. The orifice 23 forming the opening in the seal member 2 cup shape is to provide a corresponding opening to cooperate with the non cutting end 28 (see FIG. 7) of the cutting element 1. In an alternative form, the seal member may be cylindrical with the orifice 23 passing right through the seal member.

When the fibre optic cutting device 100 is in the assembled state the seal member 2 is inserted into the housing 4 sitting atop the material that physically transforms 3 without trapping air, greatly simplifying assembly of the device 100. The non cutting end 28 of the cutting element 1 may then inserted into the orifice 23 of the seal member 2 and preloads the seal to the interior surface of the cylindrical housing 4. Trapped air during assembly of the device 100 is minimised in this way, which if not minimised may impact by prematurely moving the cutting element in contact with the optical fibre member 5. The preloaded seal member 2 provides friction to ensure the cutting element 1 and seal member 2 will not easily return subsequent to activation

The height of the outer cylindrical surface of the sealing member 2 is preferably longer in length than the travel required by the sealing member 2 during actuation of the fibre optic cutting device 100. This feature ensures that the seal member 2 is always in contact with a protective surface over the activation range of movement which reduces the probability of seal member 2 failure due to corrosion of the sealing surface 14.

In the assembled state of the fibre optic cutting device 100 as shown in FIG. 1, the continuous optical fibre member 5 is retained by the retaining portions 11, 12 of the housing 4 at a position that is immediately adjacent a cutting surface 9 of the cutting element 1 moving in the direction away from the closed end 7 of the housing 4 and the material that physically transforms.

The cutting surface 9 of the cutting element 1 is composed of a sharp edge which may be provided by the perimeter region 31 of the cutting element 1 with the central portion 32 of the cutting element located below the perimeter region 32 in a V shaped depression or other shaped concavity. In such a form, the cutting element 1 may be machined out of a metal material such as brass or the like by a 90 degree spotting drill which is plunged into its face to produce sharp edges around the perimeter region 32 forming the cutting surface 9 around the perimeter of the cutting element 1.

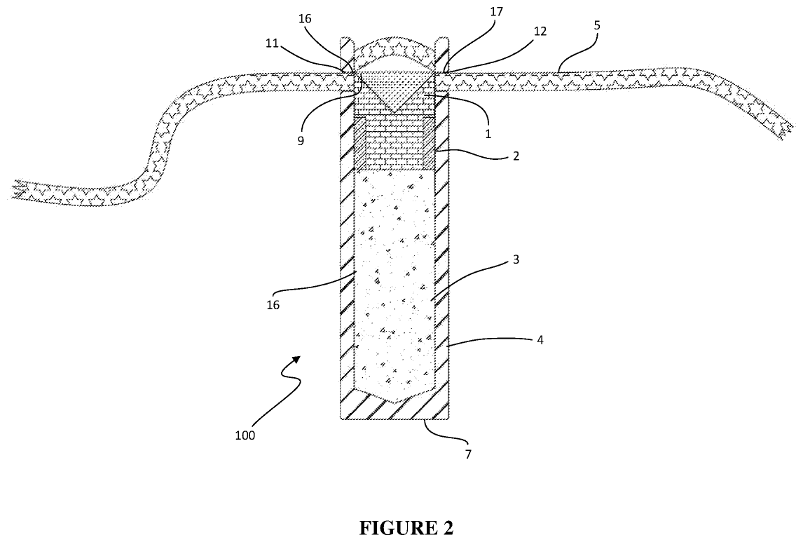

The cutting element 1 includes a cylindrical main body portion 15 that is slightly lesser in diameter than the diameter of the inside surface 16 of the housing 4. This provides that the cylindrical main body portion 15 may slide in an upright orientation through the inside of the housing 4 ensuring that the continuous cutting surface 9 around the periphery 31 of the cylindrical main body portion 15 travels immediately adjacent the inside surface 16 of the housing 4. When assembled the sealing member 2 receives the non cutting end 28 of the cutting element 1 which provides that the outer cylindrical surfaces of the seal member 14 and the cutting element 15 have substantially the same diameter which when assembled correspond to the curved surface of the inner surface of the casing 4. This form provides ease of assembly, as the cutting element 1 does not need a specific orientation like a segmented cutting blade and the cutting element may be simply placed into the cooperating orifice 23 of the seal member provided the cutting surface is in an upright orientation. Additionally, by providing the continuous cutting surface 9 is located around the periphery of the cylindrical main body portion 15 of the cutting element 1, the cutting surface 9 comes into contact with the optical fibre member 5 at two locations that are immediately adjacent the openings 11, 12 which provide the retaining portions 16, 17 (See FIG. 2). By ensuring the cutting surface 9 comes into contact with the optical fibre element 5 immediately adjacent where the optical fibre element is being held by the retaining portions the cutting element 1 will shear and effectively cut through the fibre optic element 5 with greater ease.

FIG. 1 depicts an embodiment showing the component parts of the thermally actuated fibre optic cutting device 100. The material that physically transforms 3 is located at one end of the housing 4 with the seal member 2 containing the material that physically transforms within this portion of the housing 4. The seal member 2 is located adjacent one side of the cutting element 1 with the other side of the cutting element 1, which includes the cutting surface, located adjacent a continuous portion of the optical fibre member 5. The optical fibre member 5 enters the housing 4 at an opening 11 on one side of the housing 4 and passes through the interior of the housing 4 and then exits through another opening 12 located on the other side of the housing 4. This provides for the continuous portion of the optical fibre 5 passing through the interior of the housing 4 adjacent the cutting surface 9 of the cutting element 1. In a preferred form the cutting element and the housing are composed of a metal material such as for example brass.

In a further embodiment, the openings 11, 12 can be slightly offset with respect to their location on the casing 4. In such an arrangement one opening 11 is used to retain 16 and shear the optical fiber element 5, and the other opening 12, which is positioned slightly higher (e.g. 0.5 mm) away from the closed end of the casing 4 is used to automatically pinch and retain one side of the fiber optic in the device casing. This feature may ensure that only one fiber optic end could potentially detach from the device 100 under normal operating conditions, further reducing the risk of re-creating the light path along the optical fibre element 5.

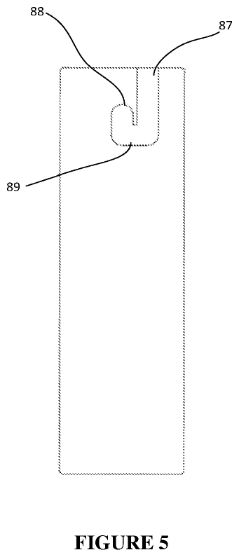

FIG. 5 depicts a further embodiment where the openings are replaced by an alternative arrangement including a vertical opening 87 in the side of the housing 4 which is in communication with a horizontal section 89 which is further in communication with a vertical section which ends in a retaining portion 88. This arrangement allows the optical fibre element to be inserted on and hooked into the housing rather than inserting the optical fibre through the openings 11, 12 which means with this arrangement the device 100 may be inserted onto an optical fibre length at any place along the length of the optical fibre.

A small section of the continuous optical fibre 5 is shown in FIG. 1 for illustrative purposes only. In the arrangement in accordance with an embodiment of the invention, the end leading to the opening 11 on one side of the housing 4 would be integrally connected to a leading end of the optical fibre member 5, and the end passing through and out of the other opening 12 of the housing 4 would be integrally connected to a trailing end of the optical fibre member 5 forming one continuous optical fibre from the leading end to the trailing end whereby a source of light may travel along the length of the optical fibre from the leading end to the trailing end. The optical fibre member 5 may be significantly long in length which provides that a fibre optic temperature sensor incorporating the thermally actuated fibre optic cutting device 100 is capable of sensing a temperature in a location a substantial distance from the trailing and/or leading ends of the optical fibre member 5.

In the event the temperature of the thermally actuated fibre optic cutting device 100 reaches predetermined temperature threshold caused by heating from the environment it is exposed to, the material that physically transforms 3 undergoes a physical transformation which results in the movement of the seal member 2 which thereby urges the cutting surface of the cutting element 1 into contact with the continuous portion of the optical fibre member 5, thereby shearing/cutting the optical fibre member 5 at the continuous portion located within the housing 4. Once the continuous portion of the optical fibre 5 is cut by the cutting element 1 this provides that the optical fibre member 5 can no longer transmit a light source along its length from the leading end to the trailing end thereby providing a signal at the trailing end of the optical fibre member 5 that the temperature at the thermally actuated fibre optic cutting device 100 has reached the predetermined temperature threshold.

The integrity of the optical fibre 5 may be assessed manually by shining a light source on the leading end of the optical fibre 5 and visually assessing whether the light source is communicated to the trailing end of the optical fibre. Alternatively, the integrity of the optical fibre may be assessed using automatic methods such as for example through the use an electronic device incorporating a transmitter and receiver including commercially available fibre optic sensors used in automation systems. In this embodiment, the light source may be chosen from any suitable light source such as for example LED, the receiver may be chosen from any suitable electronic device that is sensitive to the chosen light source, such as for example a photo transistor or photo diode devices.

In accordance with a further embodiment, the optical fibre 5 may include any number of thermally actuated fibre optic cutting devices along its length. In such an arrangement the various thermally actuated fibre optic cutting devices each individually are capable of providing a signal by cutting the optical fibre 5 in the event the temperature in the vicinity of their locations reaches a predetermined temperature threshold. Once one of the thermally actuated fibre optic cutting devices has actuated, there is no further effect provided by the actuation of any of the remaining fibre optic cutting devices as the optical fibre 5 has been cut.

The various embodiments of the thermally actuated fibre optic cutting devices may be used in conjunction with a continuous length of optical fibre thereby forming a temperature sensing system that is able to determine whether any of the thermally actuated fibre optic cutting devices have achieved a predetermined temperature threshold caused by heating from the environment. Multiple thermally actuated fibre optic cutting devices may be incorporated on the same continuous length of optical fibre which allows the thermally actuated fibre optic cutting devices to determine whether a predetermined temperature threshold of any of the multiple thermally actuated fibre optic cutting devices has been reached.

The various embodiments of the thermally actuated fibre optic cutting devices may be used in conjunction with two or more optical fibre elements that are physically disconnected yet optically joined through the use of lenses and light passing between the lenses to span the distance between the two or more optical fibre elements. In this way a temperature sensing system with physical connection between optical fibre cores can be implemented. This is highly advantageous as an optical path can therefore exist between stationary and moving objects. In the same way the optical path can also exist between stationary and rotating objects where optical continuity can be monitored each revolution. Another advantage is the temperature sensing system can be applied to high voltage equipment without introducing potential tracking paths and eliminating the possibility for partial discharge.

The thermally actuated fibre optic cutting devices in accordance with the embodiments described provide an economical way to determine whether the temperature of the one or more thermally actuated fibre optic cutting devices has reached a predetermined temperature threshold due to thermal heating from the environment being exposed too. The assembly does not require difficult optical fibre alignments between two discontinuous optical fibre sections as the optical fibre is continuous from the leading edge to the trailing edge passing right through the one or more thermally actuated fibre optic cutting devices. In addition, the mechanism which cuts the optical fibre within the sensing elements relies on the material that physically transforms which undertakes a physical transformation at a predetermined temperature threshold providing a mechanism that relies on a physical transformation rather than an electrical or frequency signal. These attributes make the fibre optic and one or more thermally actuated fibre optic cutting devices as described herein useful for a wide range of applications including for example sensing the temperature of live electrical equipment that is used in an electricity distribution system.

In a further embodiment multiple temperature threshold settings may be included in one device by adding additional fibre pass through points through the casing 4. This may include a pass through that is sheared mid way along the casing length, and one that is sheared at the top of the casing length. Individual fibre loops would be required for each pass through.

### EXAMPLE

In an example embodiment, the material that physically transforms is selected from paraffin distillation wax which undergoes a physical change by significantly expanding over at temperature range of approximately 70 to 82° C. When selected as the material that physically transforms in the assembly of the thermally actuated fibre optic cutting device as herein described this provides that the thermally actuated fibre optic cutting device cuts the continuous portion of the optical fibre when the temperature in the vicinity of the thermally actuated fibre optic cutting device reaches 80° C. In this arrangement, the predetermined temperature threshold is 80° C. and the thermally actuated fibre optic cutting device would be able to signal when the temperature reaches this level.

Many modifications will be apparent to those skilled in the art without departing from the scope of the present invention.

1. A thermally actuated fibre optic cutting device including:
a housing configured to receive an optical fibre element which passes through the housing from one side of the housing to another side of the housing in one continuous portion, wherein the optical fibre element is capable of transmitting a source of light along its length;
one or more retaining portions for retaining the optical fibre element; and,
a cutting element disposed within the housing for cutting the continuous portion of the optical fibre element in response to a change in temperature, the cutting element being moveable in a direction towards the continuous portion of the optical fibre element.

2. A thermally actuated fibre optic cutting device according to claim 1 wherein the continuous portion of the optical fibre element is cut by the cutting element at a location adjacent the retaining portion when the cutting element is moved towards the optical fibre element.

3. A thermally actuated fibre optic cutting device according to claim 1 wherein the cutting element cuts the continuous portion of the optical fibre element by shearing through the optical fibre.

4. A thermally actuated fibre optic cutting device according to claim 1 wherein the optical fibre element is in the form of one continuous length which begins at one end outside of the housing and ends at another end outside of the housing.

5. A thermally actuated fibre optic cutting device according to claim 1 wherein the cutting element is moved towards the continuous portion of the optical fibre element by a material that physically transforms due to the change in temperature wherein the material that physically transforms is contained within the housing.

6. A thermally actuated fibre optic cutting device according to claim 5 wherein the material that physically transforms is selected from a material that transforms from a solid to a liquid due to the change in temperature.

7. A thermally actuated fibre optic cutting device according to claim 6 wherein the material that physically transforms is selected from a wax composition.

8. A thermally actuated fibre optic cutting device according to claim 5 wherein the material that physically transforms is located towards and contained within one end of the housing, the cutting element is positioned adjacent the material that physically transforms, and the continuous portion of the optical fibre element is located on the other side of the cutting element from the material that physically transforms.

9. A thermally actuated fibre optic cutting device according to claim 8 wherein the cutting element includes a cutting surface located on the other side of the cutting element from the material that physically transforms and facing the continuous portion of the optical fibre element wherein the cutting surface is capable of severing the continuous portion of the fibre optic element adjacent the retaining portion when moved towards the continuous portion of the optical fibre element.

10. A thermally actuated fibre optic cutting device according to claim 8 further including a seal member located between the material that physically transforms and the cutting element.

11. A thermally actuated fibre optic cutting device according to claim 10 wherein the seal member is in the form of a hydraulic seal.

12. A thermally actuated fibre optic cutting device according to claim 10 wherein upon the change in temperature, the material that physically transforms urges the seal member and the cutting element together towards the continuous portion of the optical fibre element.

13. A thermally actuated fibre optic cutting device according to claim 10 wherein the optical fibre element passes through the housing from one side of the housing to another side of the housing in one continuous portion via two openings located in the housing, wherein the one or more retaining portions is provided by at least one or both of the perimeter surfaces of the two openings whereby the continuous portion of the fibre optic element is retained by the perimeter surface of the or both openings from moving in a direction away from the cutting element.

14. A thermally actuated fibre optic cutting device according to claim 13 wherein the perimeter surfaces of the two openings are circular in form and provide a clearance fit around the optical fibre element.

15. A thermally actuated fibre optic cutting device according to claim 9 wherein the cutting surface of the cutting element moves along an inside surface of the housing when moved towards the continuous portion of the optical fibre element.

16. A thermally actuated fibre optic cutting device according to claim 15 wherein the housing includes a cylindrical form at the location of the one or more retaining portions and the cutting surface includes a complementary shape which moves along an inside surface of the housing.

17. A thermally actuated fibre optic cutting device according to claim 16 wherein the cutting element includes a cylindrical portion including a cutting surface provided by a perimeter region located on the cylindrical portion, the cutting surface surrounding a concave central region, wherein the perimeter region of the cutting element provides a complementary shape to the inside surface of the housing.

18. A thermally actuated fibre optic cutting device including:
a housing configured to receive an optical fibre element which passes through the housing from one side of the housing to another side of the housing in one continuous portion, wherein the optical fibre element is capable of transmitting a source of light along its length; and,
a cutting element disposed within the housing for cutting the continuous portion of the optical fibre element in response to a change in temperature, the cutting element being moveable in a direction towards the continuous portion of the optical fibre element and wherein the cutting element is moved towards the continuous portion of the optical fibre element by a material.
